(19) United States
(12) Patent Application Publication
(10) Pub. No.: US 2016/0172889 A1
(43) Pub. Date: Jun. 16, 2016

(54) SYSTEM FOR CHARGING BATTERY

(71) Applicant: ELECTRONICS AND TELECOMMUNICATIONS RESEARCH INSTITUTE, Daejeon (KR)

(72) Inventors: Sung-Eun KIM, Daejeon (KR); Tae-Wook KANG, Daejeon (KR)

(21) Appl. No.: 14/864,749

(22) Filed: Sep. 24, 2015

(30) Foreign Application Priority Data
Dec. 16, 2014 (KR) 10-2014-0181679

(51) Int. Cl. H02J 7/00

(52) U.S. Cl. CPC H02J 7/0072

(57) ABSTRACT

A battery charging system is provided. The battery charging system comprises an energy harvester configured to generate power; an input capacitor configured to store the power; a first DC-DC converter configured to perform maximum power point tracking by receiving the power to extract the maximum power; a storage capacitor configured to store the maximum power; a second DC-DC converter configured to convert the maximum power to a predetermined rechargeable voltage; and a battery configured to store the power converted to the rechargeable voltage, wherein the second DC-DC converter controls to prevent a low voltage from being inputted to the capacitor and to prevent energy from being consumed uselessly in the storage capacitor while converting the voltage.

### CROSS REFERENCE TO RELATED APPLICATION

This application claims the benefit of Korean Patent Application No. 10-2014-0181679, filed on Dec. 16, 2014, entitled “System for charging battery”, which is hereby incorporated by reference in its entirety into this application.

### BACKGROUND OF THE INVENTION

1. Technical Field

Exemplary embodiments of the present invention relate to a battery charging system.

2. Description of the Related Art

in a system using an energy harvester as an input source, the energy harvester generates power and the maximum power is extracted from the generated power through maximum power point tracking (MPPT).

In order to utilize the extracted power in commercial products (e.g., battery), it is required that a constant voltage of a stored power be maintained.

A DC-DC converter is usually used to convert the stored power. Operation efficiency of the DC-DC converter varies with operation environment due to its nature. Therefore, it is needed to manage power efficiently in a process for converting power by such a DC-DC converter.

### SUMMARY OF THE INVENTION

The present invention is to provide a battery charging system which is able to efficiently control input and output conditions of a DC-DC converter performing power regulation according to an environment in order to charge a battery with the maximum power generated from a single energy harvester or more than one energy harvester.

According to an aspect of the present invention, there is provided a battery charging system.

A battery charging system according to an embodiment of the present invention may comprise: an energy harvester configured to generate power; an input capacitor configured to store the power; a first DC-DC converter configured to perform maximum power point tracking by receiving the power to extract the maximum power; a storage capacitor configured to store the maximum power; a second DC-DC converter configured to convert the maximum power to a predetermined rechargeable voltage; and a battery configured to store the power converted to the rechargeable voltage, wherein the second DC-DC converter controls on-off of an input terminal and an output terminal to prevent a low voltage from being inputted to the capacitor and to prevent energy from being consumed uselessly in the storage capacitor while converting the voltage.

The second DC-DC converter may comprise: a power regulation unit configured to raise a voltage to the rechargeable voltage which is higher than the voltage of the battery by receiving the power stored in the storage capacitor and output the raised power; an input switch configured to perform an on-off operation to control power input to the power regulation unit by being connected to an input terminal of the power regulation unit; an output switch configured to perform an on-off operation to control power output from the power regulation unit by being connected between an output terminal of the power regulation unit and the battery; and an input/output control unit configured to output a control signal to the input switch and the output switch based on an input voltage and an output voltage of the power regulation unit to control an on-off operation of the input switch and the output switch.

The input/output control unit may, when the input voltage is increased to higher than a predetermined level, turn the input switch on to input the power stored in the storage capacitor to the power regulation unit, and when the output voltage is increased to the rechargeable voltage, turn the output switch on to output the raised power to the battery.

The input/output control unit may, when all of the power stored in the storage capacitor is supplied to the battery; turn the input switch and the output switch off to block input and output of the power regulation unit.

The power regulation unit may comprise: a regulation module comprising an inductor, a first switch and a second switch and configured to raise power through an on-off operation of the first switch and the second switch to generate output power; an output voltage monitoring module configured to generate a signal to control an output voltage of the output power to be a reference voltage: a clock oscillator configured to generate a clock signal at a constant period; and a regulation control module configured to control the regulation module to a pulse width modulation mode based on the clock signal by using the signal generated from the output voltage monitoring module.

The regulation control module may output a control signal to the first switch and the second switch at every clock signal to control an on-off operation of the first switch and the second switch.

The regulation control module may control an on-off operation of the first switch and the second switch based on an on-off time ratio of the first switch and the second switch which is determined according to the signal generated from the output voltage monitoring module.

According to another aspect of the present invention, there is provided a DC-DC converter to charge a battery in a battery charging system.

A DC-DC converter according to an embodiment of the present invention may comprise: a storage capacitor configured to store input power; a power regulation unit configured to raise a voltage to the rechargeable voltage which is higher than the voltage of the battery by receiving the power stored in the storage capacitor and output the raised power; an input switch configured to perform an on-off operation to control power input to the power regulation unit by being connected to an input terminal of the power regulation unit; an output switch configured to perform an on-off operation to control power output from the power regulation unit by being connected between an output terminal of the power regulation unit and the battery; and an input/output control unit configured to output a control signal to the input switch and the output switch based on an input voltage and an output voltage of the power regulation unit to control an on-off operation of the input switch and the output switch.

According to another aspect of the present invention, there is provided a battery charging system.

A battery charging system according to an embodiment of the present invention may comprise more than one energy harvester configured to generate power; more than one input capacitor configured to store the power by being corresponded to each energy harvester; more than one first DC-DC converter configured to perform maximum power point tracking by receiving the power to extract the maximum power by being corresponded to each energy harvester; more than one storage capacitor configured to store the maximum power by being corresponded to each energy harvester; an energy accumulator configured to add the power stored in the more than one storage capacitor to one accumulate power; a storage capacitor configured to store the accumulate power; a second DC-DC converter configured to convert the accumulate power to a predetermined rechargeable voltage; and a battery configured to store the power converted to the rechargeable voltage, wherein the second DC-DC converter controls to prevent a low voltage from being inputted to the capacitor and to prevent energy from being consumed uselessly in the storage capacitor while converting the voltage.

A battery charging system according to the present invention is able to efficiently control input and output conditions of a DC-DC converter performing power regulation according to an environment in order to charge a battery with the maximum power generated from a single energy harvester or a plurality of energy harvester

### BRIEF DESCRIPTION OF DRAWING

FIG. 1 is a schematic view illustrating configuration of a battery charging system including a Harvester and a MPPT module.

FIG. 2 is a schematic view illustrating general configuration of an power regulation unit.

FIG. 3 illustrates a general wave form of an output voltage of a power regulation unit.

FIG. 4 is a graph illustrating general operation efficiency with an input voltage of a power regulation unit.

FIG. 5 is a schematic view illustrating configuration of a second DC-DC converter which controls input and output.

FIG. 6 is a graph to explain input and output control of the second DC-DC converter of FIG. 5.

FIG. 7 is a schematic view illustrating configuration of a battery charging system which charges by receiving power from more than one energy harvester.

### DESCRIPTION OF THE EXEMPLARY EMBODIMENTS

The present invention will be described with reference to particular embodiments along with the accompanying drawings. However, it is to be appreciated that various changes and modifications may be made. The exemplary embodiments disclosed in the present invention do not limit but describe the spirit of the present invention, and the scope of the present invention is not limited by the exemplary embodiments. The scope of the present invention should be interpreted that all spirits equivalent to the following claims fall with the scope of the present invention.

Throughout the description of the present invention, when describing a certain technology is determined to evade the point of the present invention, the pertinent detailed description will be omitted. While such terms as “first” and “second,” etc., may be used to describe various components, such components must not be limited to the above terms. The above terms are used only to distinguish one component from another.

When one element is described as being “connected” or “accessed” to another element, it shall be construed as being connected or accessed to the other element directly but also as possibly having another element in between.

Exemplary embodiments of the invention will be described below in more detail with reference to the accompanying drawings, in which those components are rendered the same reference number that are the same or are in correspondence, regardless of the figure number.

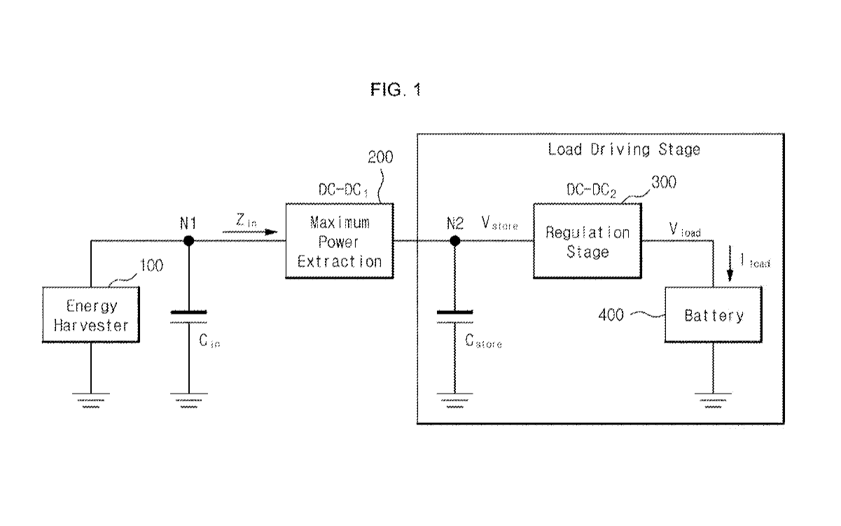

FIG. 1 is a schematic view illustrating configuration of a battery charging system including a Harvester and a MPPT module.

Referring to FIG. 1, a battery charging system may include an energy harvester 100, an input capacitor (Cᵢₙ), a first DC-DC converter 200, a storage capacitor (Cₛₜₒᵣₑ), a power regulation unit 300 and a battery 400.

The energy harvester 100 may generate power.

The input capacitor (Cᵢₙ) may be connected between a first node (N1), which is connected to the energy harvester 100, and an earth terminal, and store the power which the energy harvester 100 generates.

The first DC-DC converter 200 may be connected between the first node (N1) and a second node (N2) and perform the maximum power point tracking to extract the maximum power from the power which the energy harvester 100 generates.

The storage capacitor (Cₛₜₒᵣₑ) may be connected between the second node (N2) and the earth terminal and store the extracted maximum power. Here, voltage of the stored power may be a voltage Vₛₜₒᵣₑ.

A voltage (Vₛₜₒᵣₑ) level of the power stored in the storage capacitor (Cₛₜₒᵣₑ) cannot be predicted and the power may be needed to be regulated to an appropriate voltage to charge to or store in the battery 400.

The power regulation unit 300 may be connected between the second node (N2) and the battery 400 and regulate the power stored in the storage capacitor (Cₛₜₒᵣₑ) to a voltage level appropriate to supply to the battery 400. The power regulation unit 300 may increase the voltage of the power stored in the storage capacitor (Cₛₜₒᵣₑ) to a predetermined rechargeable voltage which is greater than the voltage of the battery 400.

The battery 400 may store by receiving power from the power regulation unit 300. The power stored in the battery 400 may be supplied to a peripheral circuit which requires power.

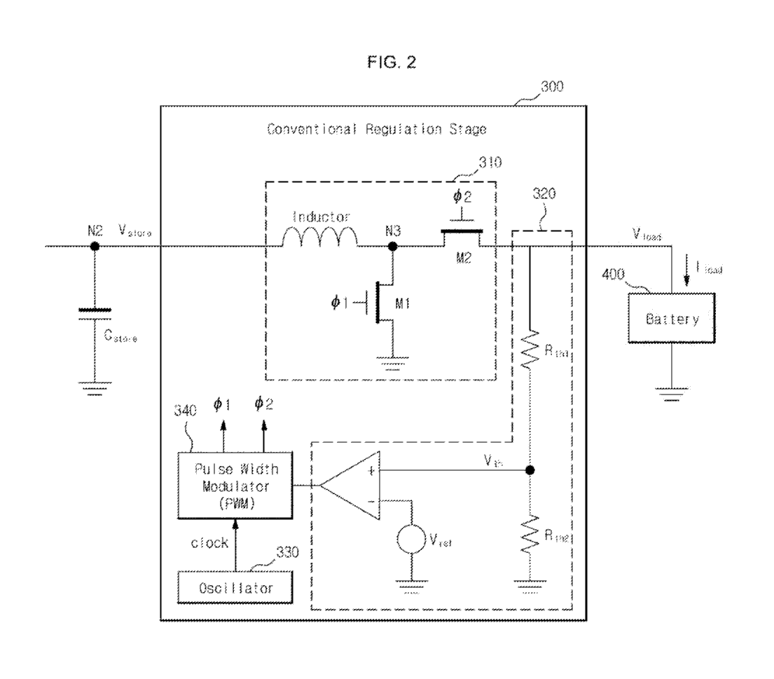

FIG. 2 is a schematic view illustrating configuration of a boost-typed power regulation unit.

Referring to FIG. 2, the power regulation unit 300 may include a regulation module 310, an output voltage monitoring module 320, a clock oscillator 330 and a regulation control module 340.

The regulation module 310 may include an inductor (L) connected between an input terminal of the power regulation unit 300 and a third node (N3), a first switch (M1) connected between the third node (N3) and the earth terminal, and a second switch (M2) connected between the third node (N3) and an output terminal. The regulation module 310 may store the power, which is inputted to the input terminal, in the inductor (L) and output the power to the output terminal to generate raised output power through an on-off operation of the first switch (M1) and the second switch (M2). Here, the first switch (M1) and the second switch (M2) may perform the on-off operation based on control signals (φ1, φ2) which the regulation control module 340 outputs. The regulation module 310 may continuously operate according to the control of the regulation control module 340 not to lower the output voltage by a load.

The output voltage monitoring module 320 may generate a signal to adjust the output voltage to a reference voltage. For example, the output voltage monitoring module 320 may include resistors configured to distribute the raised output voltage, a reference voltage oscillator configured to generate a reference voltage, and an error amplifier configured to amplify difference between the output voltage, which is voltage-distributed by the resistors, and the reference voltage. Here, the error amplifier may amplify difference between the output voltage, which is voltage-distributed by the resistors, and the reference voltage, and generate a signal which represents the amplified difference. The error amplifier may generate a signal with a high amplitude when the difference between the output voltage and the reference voltage is great, while it may generate a signal with a low amplitude when the difference between the output voltage and the reference voltage is small.

The clock oscillator 330 may generate a clock signal having a constant period. The regulation control module 340 may control an on-off operation of the first switch (M1) and the second switch (M2) based on the clock signal of the clock oscillator 330.

The regulation control module 340 may control the regulation module 310 to a pulse width modulation mode by using the signal generated from the output voltage monitoring module 320. The regulation control module 340 may control an on-off operation of the first switch (M1) and the second switch (M2) by outputting control signals (φ1, φ2) at every clock signal of the clock oscillator 330 to the regulation module 310. Here, an on-off time ratio of the first switch (M1) and the second switch (M2) may be determined based on a signal level of the error amplifier in the output voltage monitoring module 320. For example, the regulation control module 340 may keep turn-off time of the first switch (M1) to be longer than that of the second switch (M2) when the signal level of the error amplifier is great (that is, when the difference between the output voltage and the reference voltage is great), while it may keep turn-off time of the second switch (M2) to be longer than that of the first switch (M1) when the signal level of the error amplifier is small (that is, when the difference between the output voltage and the reference voltage is small).

For example, in the power regulation unit 300, an output voltage may be controlled by controlling on-duty of φ1 by voltage-distributing the raised output voltage by the resistors. In power regulation unit 300, when it is assumed that on-duty of φ1 is D, on-duty of φ2 is δ, an inputted voltage level is Vi, inductance of an inductor is L, and an operation cycle of clock is T, an output current (I₀) level may be represented by the following Equation 1.

$${I}_{0} = \frac{{I}_{L max}}{2} δ \qquad [ Equation 1 ]$$

Here, Iₘₐₓ may be represented by the following Equation 2.

$${I}_{Lmax} = \frac{{V}_{i} D T}{L} \qquad [ Equation 2 ]$$

When Equation 2 is substituted in Equation 1, the output current (I₀) may be represented by the following Equation 3.

$${I}_{0} = \frac{{V}_{i} D T}{2 L} δ \qquad [ Equation 3 ]$$

Further, the output voltage (V₀) level depending on the output current (I₀) may be represented by the following Equation 4.

$${V}_{0} = {I}_{0} {R}_{L} = \frac{{V}_{i} D T {R}_{L}}{2 L} δ \qquad [ Equation 4 ]$$

Here, R_{L} is resistance of a load connected to the power regulation unit 300.

As shown in Equation 4, If values of R_{L} and L are constant, an output voltage (V₀) may be increased by controlling the input voltage (Vi), the on-duty of φ1(D), the operation cycle of clock (T) or the on-duty of φ2(δ). That is, the output voltage (V₀) may be increased by increasing the input voltage, the on-duty of φ1, the operation cycle or on-duty of φ2. Here, the on-duty of φ2(δ) may be represented by a R_{L} function. Thus, a method for effectively converting the output voltage (V₀) in the shortest time may be a method for regulating a R_{L} level. The on-duty of φ2(δ) may be represented by the following Equation 5.

$$δ = \frac{{V}_{i} D}{( {V}_{o} - {V}_{i} )} - \frac{{V}_{o} L}{( {V}_{o} - {V}_{i} ) T {R}_{L}} \qquad [ Equation 5 ]$$

When the output voltage (V₀) is not increased to the predetermined rechargeable voltage or higher than that, the battery cannot be charged but power is just consumed. Therefore, power regulation to increase the output voltage is needed.

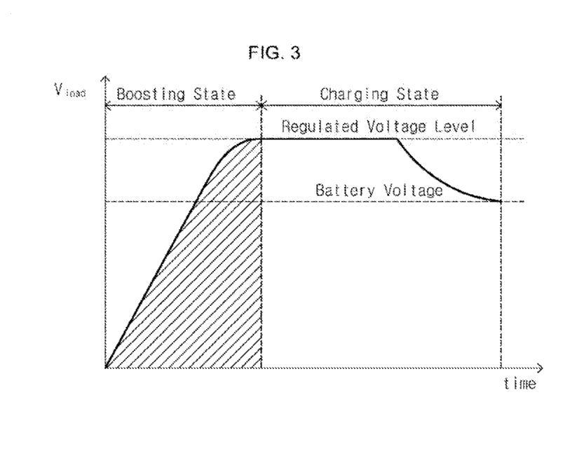

FIG. 3 illustrates a wave form of an output voltage of a power regulation unit.

As shown in FIG. 3, since an output voltage level is not higher than that of the battery voltage in a boosting state, the battery 400 cannot be charged. A charging state can be only when the output voltage level reaches a regulated voltage level. The output voltage increases with power input but since the power is just consumed in the boosting state which is before it reaches the regulated voltage level, the power is not supplied to the battery 400. However, when the output voltage is increased to the regulated voltage level, the power regulation unit 300 may charge the battery 400 by using the power stored in the storage capacitor (Cₛₜₒᵣₑ). The output voltage (V_{load}) may maintain a certain regulated voltage level and then drop to the battery voltage when all power stored in the storage capacitor (Cₛₜₒᵣₑ) is consumed. Therefore, a method for prevent from additional consumption of the power charged in the battery 400 is needed.

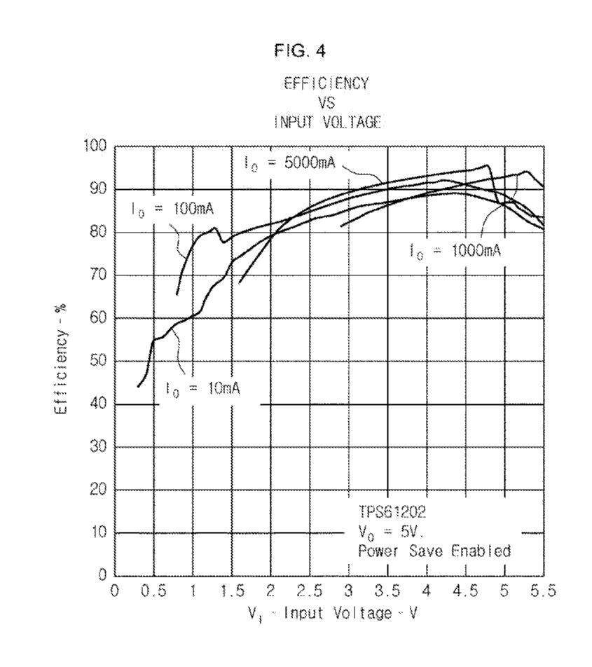

FIG. 4 is a graph illustrating operation efficiency with an input voltage of a power regulation unit.

Properties of a battery charging system are apt to be changed depending on a driving current level but when an input voltage is low, it generally causes degradation of efficiency of the entire system. It is due to a voltage drop for on-resistance which is caused from the first switch (M1) and the second switch (M2) with high current flow. When an input voltage has to be increased in multiples since it is too low, the power level which is consumed due to increased operation frequency of an entire system has to be high. Therefore, a method for controlling the input voltage level is needed in order to prevent such problems.

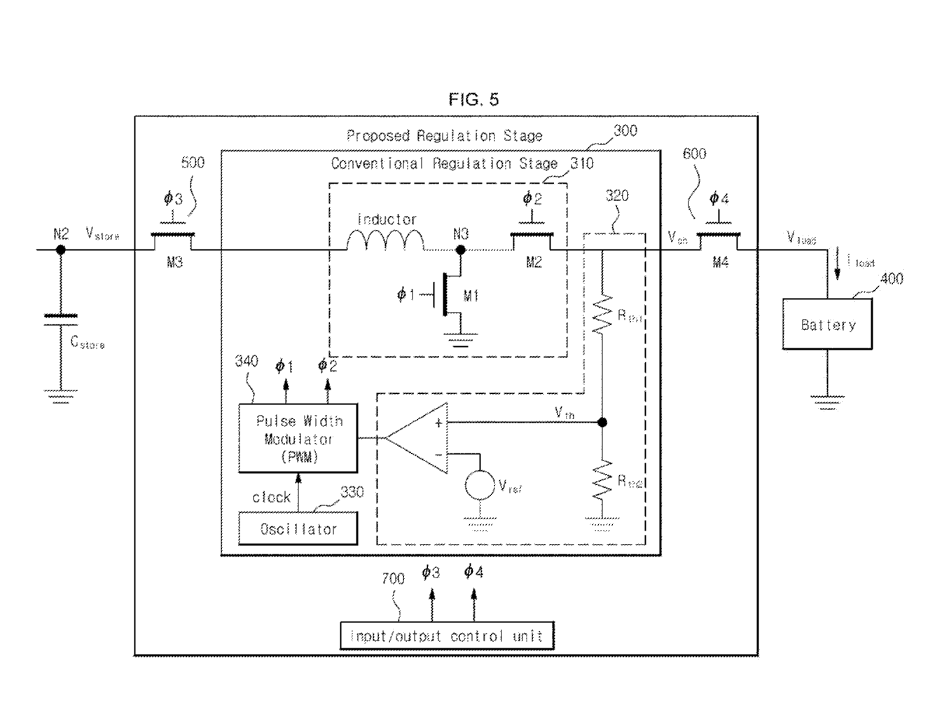

FIG. 5 is a schematic view illustrating configuration of a second DC-DC converter which controls input and output.

Referring to FIG. 5, a second DC-DC converter which controls input and output may include a power regulation unit 300, an input switch (M3) 500 and an output switch (M4) 600 configured to be connected to an input terminal and an output terminal of the power regulation unit 300, respectively, and an input/output control unit 700 configured to control the input switch (M3) 500 and the output switch (M4) 600. Here, since detailed description about the power regulation unit 300 has been described with reference to FIG. 2, it will be omitted.

The input switch (M3) 500 may be connected between a second node (N2) which is connected with a storage capacitor (Cₛₜₒᵣₑ) and the input terminal of the power regulation unit 300, and perform an on-off operation based on a control signal (φ3) of the input/output control unit 700 to control power input toward the power regulation unit 300.

The output switch (M4) 600 may be connected between the output terminal of power regulation unit 300 and the battery 400, and perform an on-off operation based on a control signal (φ4) of the input/output control unit 700 to control power output from the power regulation unit 300.

The input/output control unit 700 may control on-off operations of the input switch (M3) 500 and the output switch (M4) 600 by outputting the control signals (φ3, φ4) to the input switch (M3) 500 and the output switch (M4) 600 based on the input voltage (Vₛₜₒᵣₑ) and the output voltage (V_{ch}) of the power regulation unit 300, respectively. The input/output control unit 700 may control on-off operations of the input and output terminals of the power regulation unit 300 in order to prevent the input voltage (Vₛₜₒᵣₑ) of the power regulation unit 300 from being lowered and also prevent the power charged in the battery 400 from being additionally consumed.

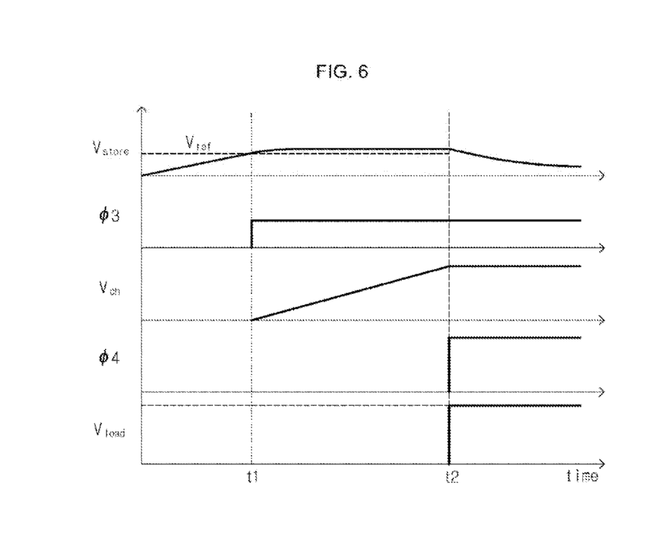

For example, FIG. 6 is a graph to explain input and output control of the second DC-DC converter of FIG. 5. FIG. 6 illustrates output wave forms of the control signals (φ3, φ4) according to the input voltage (Vₛₜₒᵣₑ) and the output voltage (V_{ch}). Referring to FIG. 6, voltage of the input voltage (Vₛₜₒᵣₑ) may be increased as power level of the storage capacitor (Cₛₜₒᵣₑ) which performs power input function increases. When the input voltage (Vₛₜₒᵣₑ) becomes higher than the predetermined reference level (V_{ref}) which is an input voltage level to maximize efficiency of the second DC-DC converter, the input/output control unit 700 may turn the control signal φ3 on to input the power of the storage capacitor (Cₛₜₒᵣₑ) to the power regulation unit 300. When a rechargeable voltage of the battery 400 increases as the output voltage (V_{ch}) of the power regulation unit 300 increases, the input/output control unit 700 may turn the control signal φ4 on to output the power which is increased to the rechargeable voltage to the battery 400. A voltage (V_{load}) to the battery 400 may be increased to the output voltage (V_{ch}) when the control signal φ4 is turned on. The power of the storage capacitor (Cₛₜₒᵣₑ) which supplies the power to the battery 400 begins to decrease to be supplied to the battery 400 till drive of the power regulation unit 300 stops. Thus, when all the power of the storage capacitor (Cₛₜₒᵣₑ) is supplied to the battery 400, the input/output control unit 700 may turn the control signals φ3 and φ4 off to turn the input switch (M3) 500 and the output switch (M4) 600 off to block input and output of the power regulation unit 300. Then, when power is again supplied from the energy harvester 100 and the voltage (Vₛₜₒᵣₑ) of the storage capacitor (Cₛₜₒᵣₑ) increases, the input/output control unit 700 may repeat the operation described above.

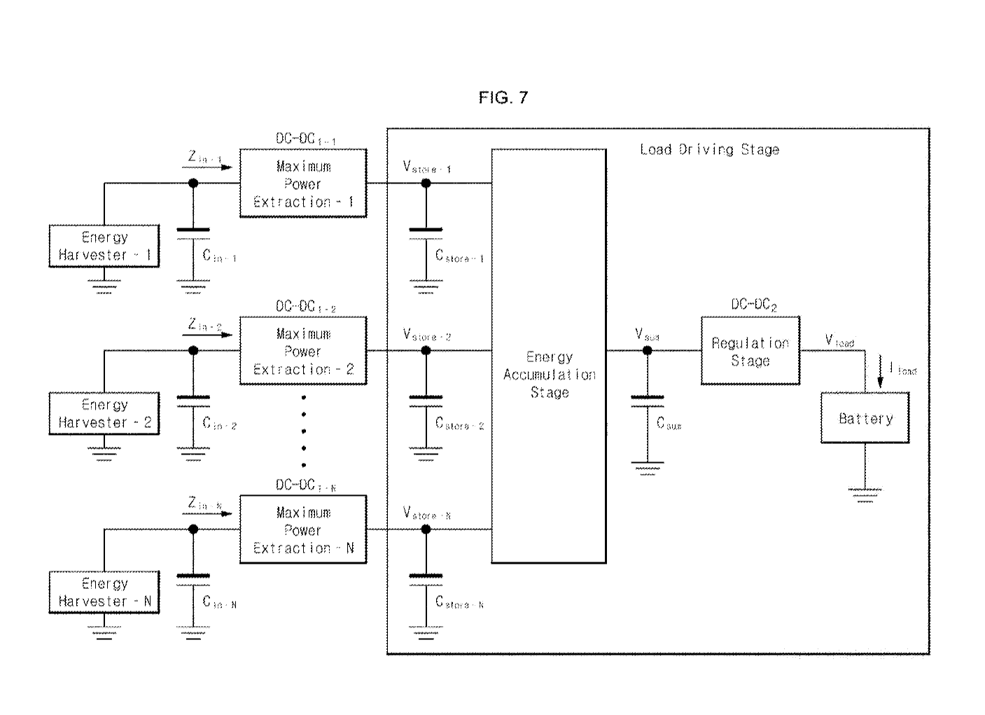

FIG. 7 is a schematic view illustrating configuration of a battery charging system which charges by receiving power from more than one energy harvester.

Referring to FIG. 7, a battery charging system which charges with the power supplied from more than one energy harvester may include more than one energy harvester, more than one input capacitor (Cᵢₙ) configured to store the power by being corresponded to each energy harvester, more than one first DC-DC converter configured to perform maximum power point tracking by being corresponded to each energy harvester, more than one storage capacitor configured to store the power extracted through the maximum power point tracking, an energy accumulator configured to add the power stored in the more than one storage capacitor to one accumulate power to store in a storage capacitor (Cₛᵤₘ), the storage capacitor (Cₛᵤₘ) configured to store the accumulated power, a power regulation unit configured to convert the accumulate power stored in the storage capacitor (Cₛᵤₘ), and a battery configured to charge the converted accumulate power. Here, the power regulation unit which converts the accumulate power is identical to the second DC-DC converter which controls input and output in FIG. 5

The spirit of the present invention has been described by way of example hereinabove, and the present invention may be variously modified, altered, and substituted by those skilled in the art to which the present invention pertains without departing from essential features of the present invention.

### DESCRIPTION OF REFERENCE NUMERALS

100: energy harvester
200: first DC-DC converter
300: power regulation unit
400: battery
500: input switch
600: output switch
700: input/output control unit

What is claimed is:

1. A battery charging system comprising:
an energy harvester configured to generate power;
an input capacitor configured to store the power;
a first DC-DC converter configured to receive the power and perform maximum power point tracking by receiving the power to extract the maximum power;
a storage capacitor configured to store the maximum power;
a second DC-DC converter configured to convert the maximum power to a predetermined rechargeable voltage; and
a battery configured to store the power converted to the rechargeable voltage,
wherein the second DC-DC converter controls to prevent a low voltage from being inputted to the capacitor and to prevent energy from being consumed uselessly in the storage capacitor while converting the voltage.

2. The battery charging system of claim 1, wherein the second DC-DC converter comprises:
a power regulation unit configured to raise a voltage to the rechargeable voltage which is higher than the voltage of the battery by receiving the power stored in the storage capacitor and output the raised power;
an input switch configured to perform an on-off operation to control power input to the power regulation unit by being connected to an input terminal of the power regulation unit;
an output switch configured to perform an on-off operation to control power output from the power regulation unit by being connected between an output terminal of the power regulation unit and the battery; and
an input/output control unit configured to output a control signal to the input switch and the output switch based on an input voltage and an output voltage of the power regulation unit to control an on-off operation of the input switch and the output switch.

3. The battery charging system of claim 2, wherein the input/output control unit, when the input voltage is increased to higher than a predetermined level, turns the input switch on to input the power stored in the storage capacitor to the power regulation unit and when the output voltage is increased to the rechargeable voltage, turns the output switch on to output the raised power to the battery.

4. The battery charging system of claim 3, wherein the input/output control unit, when all of the power stored in the storage capacitor is supplied to the battery, turns the input switch and the output switch off to block input and output of the power regulation unit.

5. The battery charging system of claim 2, wherein the power regulation unit comprises:
a regulation module comprising an inductor, a first switch and a second switch and configured to raise power through an on-off operation of the first switch and the second switch to generate output power;
an output voltage monitoring module configured to generate a signal to control an output voltage of the output power to be a reference voltage;
a clock oscillator configured to generate a clock signal at a constant period; and
a regulation control module configured to control the regulation module to a pulse width modulation (PMW) mode based on the clock signal by using the signal generated from the output voltage monitoring module.

6. The battery charging system of claim 5, wherein the regulation control module outputs a control signal to the first switch and the second switch at every clock signal to control an on-off operation of the first switch and the second switch.

7. The battery charging system of claim 6, wherein the regulation control module controls an on-off operation of the first switch and the second switch based on an on-off time ratio of the first switch and the second switch which is determined according to the signal generated from the output voltage monitoring module.

8. A DC-DC converter which is to charge a battery in a battery charging system, the DC-DC converter comprising:
a storage capacitor configured to store input power;
a power regulation unit configured to raise a voltage to the rechargeable voltage which is higher than the voltage of the battery by receiving the power stored in the storage capacitor and output the raised power;
an input switch configured to perform an on-off operation to control power input to the power regulation unit by being connected to an input terminal of the power regulation unit;
an output switch configured to perform an on-off operation to control power output from the power regulation unit by being connected between an output terminal of the power regulation unit and the battery; and
an input/output control unit configured to output a control signal to the input switch and the output switch based on an input voltage and an output voltage of the power regulation unit to control an on-off operation of the input switch and the output switch.

9. A battery charging system comprising:
more than one energy harvester configured to generate power;
more than one input capacitor configured to store the power by being corresponded to each energy harvester;
more than one first DC-DC converter configured to perform maximum power point tracking by receiving the power to extract the maximum power by being corresponded to each energy harvester;
more than one storage capacitor configured to store the maximum power by being corresponded to each energy harvester;
an energy accumulator configured to add the power stored in the more than one storage capacitor to one accumulate power;
a storage capacitor configured to store the accumulate power;
a second DC-DC converter configured to convert the accumulate power to a predetermined rechargeable voltage; and
a battery configured to store the power converted to the rechargeable voltage,
wherein the second DC-DC converter controls to prevent a low voltage from being inputted to the capacitor and to prevent energy from being consumed uselessly in the storage capacitor while converting the voltage.
